(19) United States
(12) Patent Application Publication
(10) Pub. No.: US 2002/0047739 A1
(43) Pub. Date: Apr. 25, 2002

(54) Modified clock signal generator

(76) Inventor: Timothy Charles Mace, Haverhill (GB)

Correspondence Address: NIXON & VANDERHYE P.C., 1100 North Glebe Road, 8th Floor, Arlington, VA, 22201-4714, US

(21) Appl. No.: 09/944,388

(22) Filed: Sep. 4, 2001

(30) Foreign Application Priority Data
Oct. 24, 2000 (GB) 0026033.1

(51) Int. Cl. G06F 1/04

(52) U.S. Cl. 327/291

(57) ABSTRACT

A circuit 2 for generating a modified clock signal from an input clock signal is provided by a delay line formed of digitally controlled delay line elements between DE₁, DE₂, DE₃, DE₄ which a state change propagates. The feedback control applied to the delay line may be arranged such that the system is only stable when locked upon a state in which a predetermined number of signal changes are propagating along the delay line. The digital control of the delay line elements may be Gray coded.

### BACKGROUND OF THE INVENTION

1 . Field of the Invention

This invention relates to the field of clock signal generation. More particularly, this invention relates to the generation of a modified clock signal from an input clock signal.

2 . Description of the Prior Art

It is known within the field of electronics, and particularly digital electronics, that clock signals for controlling the operation of an electronic circuit may require different characteristics for different parts of the circuit. As an example, it may be desired that one portion of the circuit should run with a slow clock signal and another portion of the circuit run with a fast clock signal. In order that the different portions of the circuit interact correctly, it is often desirable that there should be some fixed phased relationship between different clock signals controlling different portions of the circuit.

It is known to generate modified clock signals starting from an input clock signal using analogue circuitry, such as phase locked loops (PLLs). Whilst the performance in terms of the clock signals generated by these analogue circuits may be good, there is a problem in incorporating such analogue circuits within systems that may otherwise be entirely digital. In particular, analogue components are not well suited to incorporation within an integrated circuit as minor manufacturing process variations that are acceptable for digital components can produce unacceptable variations within components of an analogue circuit. Furthermore, analogue components tend to be physically much larger and accordingly occupy a disadvantageously large portion of the area of an integrated circuit.

### SUMMARY OF THE INVENTION

Viewed from one aspect the present invention provides an apparatus for generating a modified clock signal from an input clock signal, said modified clock signal having a substantially fixed phase relationship to said input clock signal, said apparatus comprising a delay line having a plurality of serially connected gates acting as delay line elements, said input clock signal being input to said delay line to trigger periodic signal state changes that propagate along said delay line; a delay controller responsive to one or more digital control values for controlling a propagation delay provided by said plurality of serially connected gates acting as delay line elements; and clock signal generating logic responsive to said signal state changes to generate said modified clock signal.

The invention recognises that digital control may be applied to the generation of a modified clock signal to yield an acceptable modified clock signal without the need to rely upon analogue circuitry. It might be expected that in order to achieve a good quality stable modified clock signal, then the effectively infinitely fine level of control provided by an analogue circuit would be necessary. However, the present invention recognises that in a modified clock signal generator based upon a delay line, digital control of the propagation delays along the delay line can provide a sufficiently stable and fine level of control to produce an acceptable modified clock signal. Furthermore, avoiding the need for analogue circuitry allows the modified clock signal generator to have a higher degree of resistance to manufacturing process variation and also be provided using a smaller amount of integrated circuit area.

In order to derive a modified clock signal from a delay line based system it is convenient to provide tap points between gates acting as delay line elements making up the delay line. These tap points will have a temporal relationship between the signal changes that occur at them that is dependent upon the control of the propagation delay along the delay line.

Considerable flexibility in the nature of the modified clock signal that may be generated can be achieved from a given design by the provision of clock signal generating logic that is responsive to signal state changes at a plurality of tap points along the delay line to generate the modified clock signal. In this way, the particular nature of the relationship between the input clock signal and the modified clock signal can be adjusted by changing the way in which the clock signal generating logic responds to signals at tap points and by moving those tap points.

Stable and reliable performance may be achieved by using an edge triggered delay line in which an input clock signal edge in a particular direction is used to trigger a signal state change along the delay line. It is advantageous for the clock circuit to respond to the same event as is used in triggering other state changes within a circuit.

Whilst it is possible to generate a modified clock signal without the use of feedback control, the accuracy of the modified clock signal and the stability of the system will generally be significantly increased by the provision of a feedback controller using feedback from a delayed signal generated by the delay line to adjust the digital control values that control the propagation delay so as to maintain a predetermined relationship between the input clock signal and the state changes propagating along the delay line, and consequently the modified clock signal generated.

An advantageously stable and relatively simple to implement arrangement is one in which the predetermined relationship used by the feedback control is one in which a state change propagates along the delay line in a time substantially equal to a clock period of the input clock signal.

With such an arrangement undesirable situations in which the delay line and feedback locks on to an incorrect frequency may be avoided by arranging the feedback controller such that it does not change the digital values to increase the propagation delay unless the signal values from all the tap points indicate that a predetermined number of signal state changes are propagating along the delay line in a given time period. This helps to avoid the delay line locking onto a state in which too many signal state changes are propagating along the delay line despite having the desired fixed phase relationship to the input clock signal.

It will be appreciated that the delay elements that form the delay line could all be controlled by a common digital value. However, a finer degree of control with a minimal increase in circuit area and complexity can be achieved by providing that each element within the delay line is separately controlled by its own digital value.

The glitch resistance and stability of the circuit can be improved by arranging that the digital values that control the delay change in accordance with a Gray coding.

The delay elements to be controlled by a digital value may be conveniently provided by a serially connected arrangement of non-clocked gates with the output of the delay element being picked off from an output of one of the non-clocked gates using a multiplexer. It is beneficial to arrange for a distributed arrangement of inverting elements along the delay line to preserve the pulse widths.

The stability of the system may be improved by latching the inverter outputs and using these latched values to control generation of the modified clock signal, thereby avoiding any effects due to fluctuations upon the signal values output by the inverters.

Whilst in many practical situations the modified clock signal that is desired may be a simple integer multiple of the input clock signal, the techniques of the present invention are not limited to such relationships and a wide variety of fixed phase numerical relationships between the modified clock signal and the input clock signal may be achieved using the principle of the invention.

Viewed from another aspect the present invention provides a method of generating a modified clock signal from an input clock signal, said modified clock signal having a fixed phase relationship to said input clock signal, said apparatus comprising: inputting said input clock signal to a delay line having a plurality of serially connected delay line elements to trigger periodic signal state changes that propagate along said delay line; in response to one or more digital control values, controlling a propagation delay provided by said plurality of serially connected delay line elements; and in response to said signal state changes generating said modified clock signal.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a circuit for generating a modified clock signal from an input clock signal;

FIG. 2 illustrates the relationship between an input clock signal, state changes propagating along a delay line and a modified output clock signal;

FIG. 3 illustrates a delay element;

FIG. 4 illustrates a more complex relationship between the input clock frequency and the output clock frequency; and

FIG. 5 schematically illustrates a further example embodiment of a circuit for generating a modified clock signal from an input clock signal.

### DESCRIPTION OF THE PREFERRED EMBODIMENTS

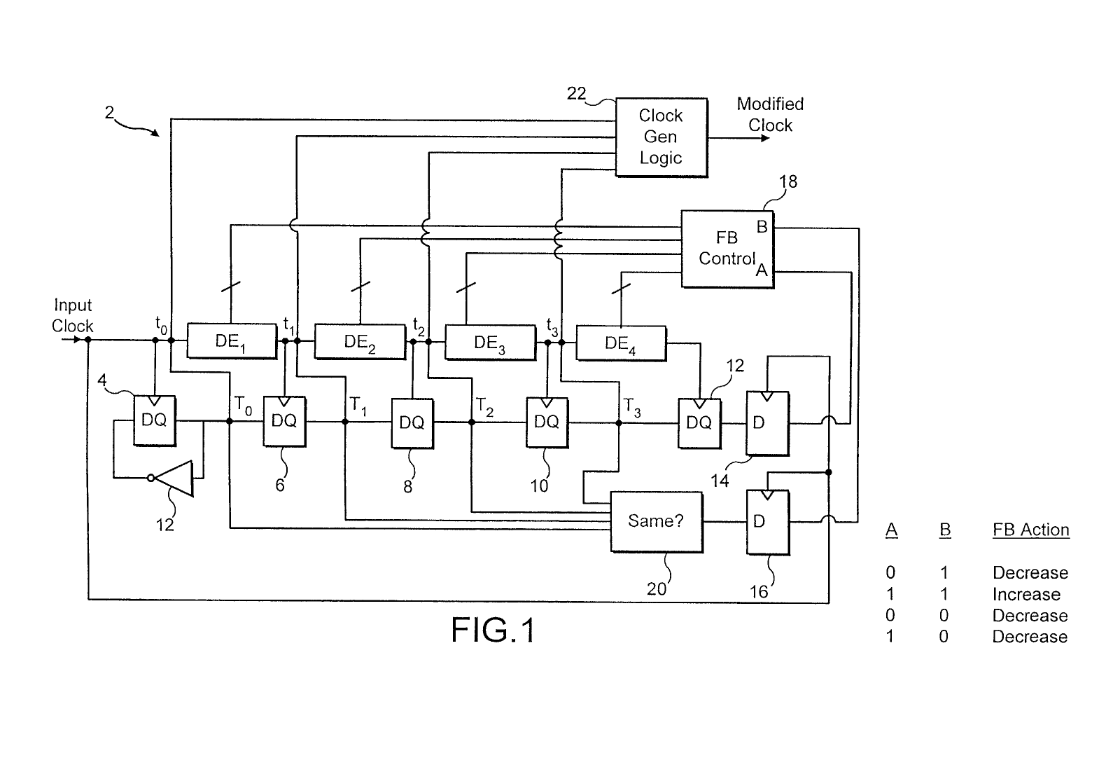

FIG. 1 illustrates a circuit 2 for generating a modified clock signal from an input clock signal. The circuit 2 may be provided upon an integrated circuit using digital components. Circuit 2 includes a delay line formed of four delay line elements DE₁, DE₂, DE₃, and DE₄. An input clock signal applied to the delay line propagates along the delay line with each of the delay line elements introducing approximately a quarter input clock period delay. The input to the first delay element DE₁, provides the first tap signal T₀. The other tap signals T₁, T₂, T₃, and T₄ each having a further quarter input clock period delay are provided between following adjacent delay elements. Four latches 4, 6, 8, 10 are associated with respective delay elements. When one of these latches 4, 6, 8, 10 receives the rising edge of the input clock signal, it stores the signal value being provided to its D input and subsequently outputs this signal value at its Q output until it receives the next rising edge. The first latch 4 is provided with an inverter feedback loop 12 that serves to force the latch 4 to alternately store a high and a low signal level, each change occurring upon the occurrence of each rising edge of the input clock signal. Accordingly, the output of the latch 4 is a square wave having half the frequency of the input clock signal.

The alternating output of the latch 4 represents a signal state change that is propagated along the delay line passing between the further latches 6, 8, and 10 at a time period controlled by the gating of respective latches by their particular delay element DE₁, DE₂, DE₃. The quarter input clock period delays provided by the delay elements serve to space the state changes in the propagated signal by a quarter period at each latch.

The final delay element DE₄ and its associated latch 12 are used for feedback control of the digital values that control the propagation delays provided by the respective delay elements element DE₁, DE₂, DE₃ and DE₄.

Two feedback control latches 14 and 16 are provided. The feedback control 14 is triggered to sample the output of the latch 12 at the rising edge of the input clock signal. Thus, given that the each of the delay elements DE₁, DE₂, DE₃ and DE₄ is intended to introduce a quarter input clock period delay, then a rising edge in the propagating state change between the latches 4, 6, 8, 10 and 12 should just have reached the latch 12 and be stored therein at the time at which the latch 14 samples the latch 12. If the propagating state change has not reached the latch 12, then the propagation delays introduced by the delay elements should be decreased by the action of the feedback controller 18. Conversely, if the change is already stored within the latch 12 then the delay may, subject to further considerations, need to be increased. It will be appreciated that this control will locked on and then fluctuate to either side of the propagation delay matching the input clock signal period.

As mentioned above, when the latch 14 indicates a need to increase the propagation delay, this is qualified by detecting that not more than one state change is propagating along the line of latches, 4, 6, 8 and 10. In particular, it is desired in this example to avoid two or more state changes propagating along the line of latches 4, 6, 8 and 10 in a single input clock period and this being locked onto by the feedback arrangement. The situation is avoided by comparison circuitry 20 that acts to determine if each of the tap signals has the same value with the result being sampled by the latch 16 at the rising edge of the input clock signal. If the comparison circuitry 20 indicates that at the sample point of the rising edge of the input clock signal the tap values do not all have the same value, then this indicates that more than one change in value is propagating along the latch chain and accordingly the delay element propagation delays should be decreased irrespective of what the result of the signal sampled by the latch 14 shows.

The relationship between the value A latched by the latch 14, the value B latched by the latch 16 and the change actioned by the feedback controller 18 is illustrated in the table in FIG. 1.

The feedback controller 18 generates four individual digital values that are supplied to respective delay elements DE₁, DE₂, DE₃ and DE₄ to control the propagation delay generated by these respective elements. The digital values may be individually varied so as to adjust the total delay period introduced by the delay line. In practice it may be convenient to adjust the delays of respective delay elements in a predetermined sequence.

The tap signal values T₀, T₁, T₂ and T₃ are each provided to the clock generator logic 22 that serves to combine these to generate the modified clock signal. The tap signals have a fixed time and phase relationship relative to the input clock signal. This is exploited by the clock generator logic 22 to provide a modified clock signal has a stable and desired relationship to the input clock signal.

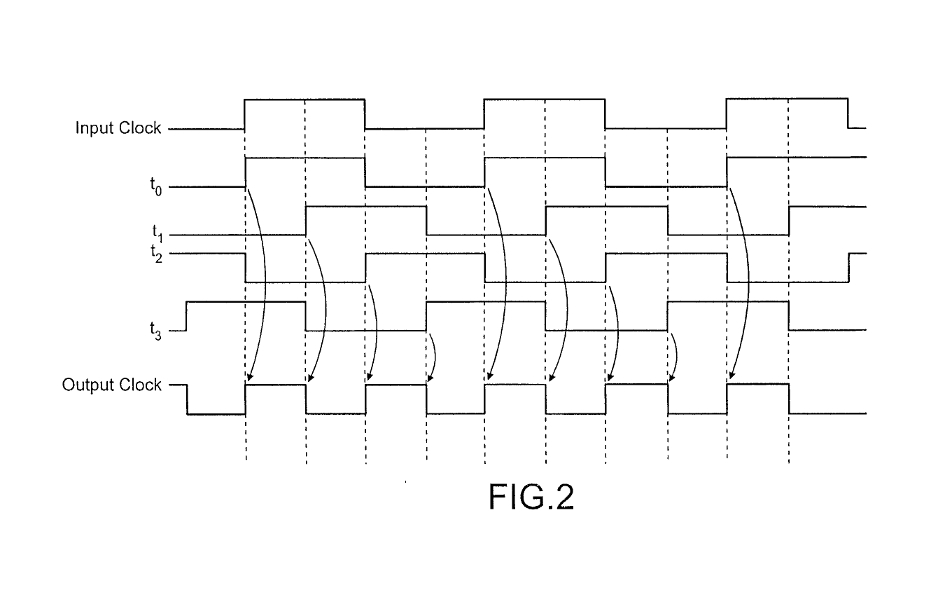

FIG. 2 schematically illustrates the relationship between the input clock signal, the signals t₀, t₁, t₂ and t₃ and the output clock signal. In particular, it will be seen that a rising edge in the input clock signal triggers a change of value in the tap signal t₀. The change in the tap signal value t₀ is followed a quarter of an input clock period later by the same change in the following tap signal value t₁. This relationship is repeated between the following tap signals t₂ and t₃. Accordingly, if the feedback within the circuit of FIG. 1 is correctly locked, then the signals t₀, t₁, t₂ and t₃ will produce a sequence of rising edges spaced by quarter input clock signal periods from one another. These rising edges are used by the clock generator logic 2 using standard techniques to generate an output clock signal with twice the frequency of the input clock signal.

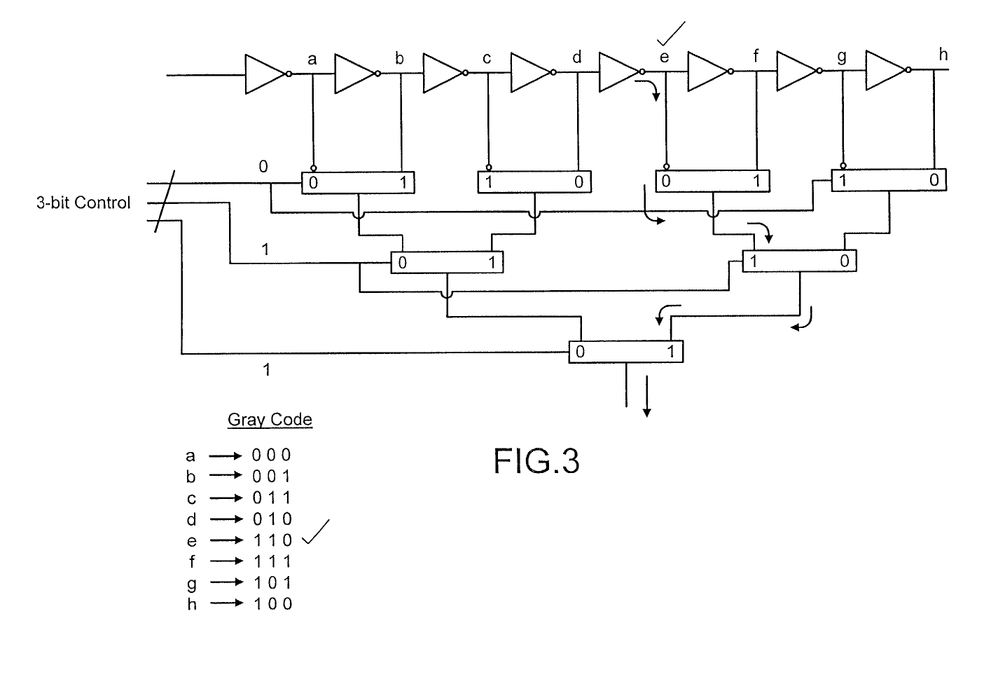

FIG. 3 illustrates a simplified delay element formed of a chain of non-clocked gates, in this case inverters. A change in input signal value is applied to the first gate and then propagates along the chain of gates with a change in the output signal of each gate being slightly delayed from that of the preceding gate. The delay to be introduced by the delay element can be selected by picking off one of the signal value changes at any point in the delay line and then using this as the output from that delay element. Selection is achieved by a branched arrangement of multiplexers controlled by a digital value. In the example shown, the branched array of multiplexers is three levels deep and is controlled by a 3-bit digital value. The signal “e” between the fifth and the sixth gates is the selected signal chosen to have the desired propagation delay from the input to the first gate. The 3-bit control value that configures the multiplexers to select this value for output is “110” . It will be seen that the control of the multiplexers with the respective bit values may be arranged such that a Gray coding is provided between the 3-bit control value and the selected delay in a manner that reduces glitches due to changes in the 3-bit control value.

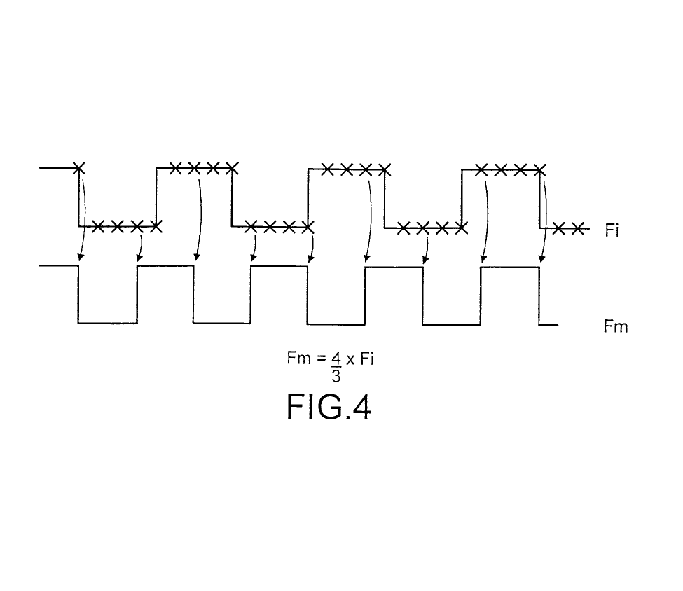

FIG. 4 schematically illustrates a more complex relationship between an input clock signal and a modified clock signal. In the example shown, the modified clock signal has a frequency that is 4/3 times that of the input clock signal. The delay line used is arranged so as to provide a ⅜ input clock signal period delay between each delay element and have three state changes propagating along the delay line in its stable condition. The changes in value at each of the tap points on this delay line can then be used to trigger a value change in the modified output signal in a manner such that the cycle repeats with four modified clock signal periods being fitted within three input clock signal periods.

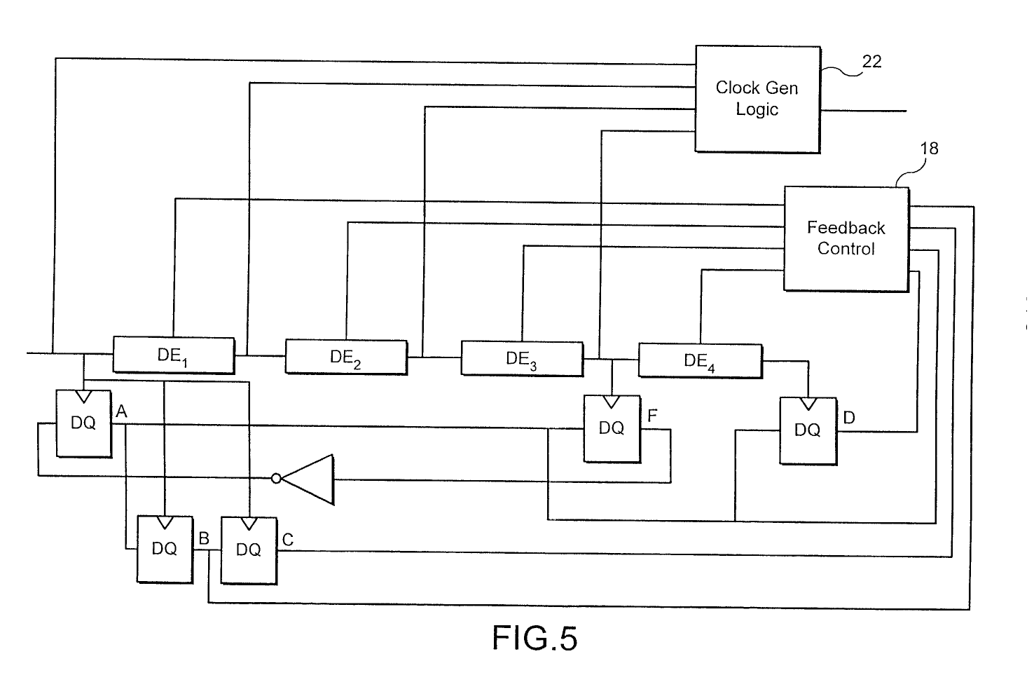

FIG. 5 schematically illustrates a further example embodiment of a circuit for generating a modified clock signal. This circuit differs from the circuit of FIG. 1 in the manner in which the feedback control of the delay elements is provided.

The register generating signal F is triggered from the clock delayed through the first three delay elements; DE1, DE2 and DE3. In the more general case this register will be triggered from the clock delayed through to the output of the penultimate of N delay elements forming an N delay element delay line. The objective of the feedback is to ensure that the delay through all N delay elements is equal to the period of the input clock. It can be seen that, if the delay through the first N-1 delay elements is less than the period of the input clock then the register generating signal F will have captured at its input the signal A. This will cause the value of A to alternate after each rising edge of the input clock.

It can be seen that if the values of A B and C are 1, 0, 1 or 0, 1, 0 respectively then the total delay of the first N-1 delay elements is less than the period of the input clock. The delay of all N delay elements is therefore less than (N+1)/N times the input clock period.

If the value at D is equal to that at A at the rising edge of the input clock then the length of the delay through all N delay elements is less than the period of the input clock.

It can be seen that if, and only if, both of these aforementioned conditions are met then the period of the N delay elements in series is less than the period of the input clock and therefore the Feedback control should increase the delay, otherwise the Feedback control should decrease the delay through the elements.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim:

1. Apparatus for generating a modified clock signal from an input clock signal, said modified clock signal having a substantially fixed phase relationship to said input clock signal, said apparatus comprising:
(i) a delay line having a plurality of serially connected gates acting as delay line elements, said input clock signal being input to said delay line to trigger periodic signal state changes that propagate along said delay line;
(ii) a delay controller responsive to one or more digital control values for controlling a propagation delay provided by said plurality of serially connected gates acting as delay line elements; and
(iii) clock signal generating logic responsive to said signal state changes to generate said modified clock signal.

2. Apparatus as claimed in claim 1, wherein tap points are provided between gates acting as delay line elements.

3. Apparatus as claimed in claim 1, wherein said clock signal generating logic is responsive to signal state changes at a plurality of tap points along said delay line to generate said modified clock signal.

4. Apparatus as claimed in any one of the preceding claims, wherein a clock signal edge, being a change in said input clock signal from a first value to a second value, triggers said signal state changes.

5. Apparatus as claimed in any one of the preceding claims, wherein a feedback controller uses feedback from a delayed signal generated by said delay line to adjust said digital control values to maintain a predetermined relationship between said input clock and said signal state change propagating along said delay line.

6. Apparatus as claimed in claim 5, wherein said predetermined relationship is such that said signal state changes propagates along said delay line in a time substantially equal to one clock period of said input clock signal.

7. Apparatus as claimed in claim 2 and any one of claims 3 to 6, wherein said feedback controller does not change said digital values to increase said propagation delays unless signal values at said tap points indicate that a predetermined number of signal state changes are propagating along said delay line in a given time period.

8. Apparatus as claimed in claim 7, wherein said feedback controller does not change said digital values to increase said propagation delays unless signal values at all of said tap points indicate that a single signal state change is propagating along said delay line in an input clock signal period.

9. Apparatus as claimed in any one of the preceding claims, wherein each delay element provides a propagation delay controlled by a digital value for that delay element.

10. Apparatus as claimed in any one of the preceding claims, wherein said one or more digital values change in accordance with a Gray coding.

11. Apparatus as claimed in any one of the preceding claims, wherein each delay element comprises a plurality of serially connected non-clocked gates between which said signal state change propagates and a multiplexer controlled by a digital value for selecting a non-clocked gate output of one of said non-clocked gates to control output of said delay element.

12. Apparatus as claimed in claim 11, wherein at least some of said non-clocked gates act as inverters.

13. Apparatus as claimed in any one of the preceding claims, wherein said modified clock signal has a frequency fₘ, said input clock signal has a frequency fᵢ and fₘ is substantially equal to N/M*fᵢ, N and M being positive integers.

14. A method of generating a modified clock signal from an input clock signal, said modified clock signal having a fixed phase relationship to said input clock signal, said apparatus comprising:
(i) inputting said input clock signal to a delay line having a plurality of serially connected gates acting as delay line elements to trigger periodic signal state changes that propagate along said delay line;
(ii) in response to one or more digital control values, controlling a propagation delay provided by said plurality of serially connected gates acting as delay line elements; and
(iii) in response to said signal state changes generating said modified clock signal.
